(19) United States
(12) Patent Application Publication
(10) Pub. No.: US 2026/0276988 A1
(43) Pub. Date: Sep. 17, 2026

(54) OPTICAL ARRANGEMENT FOR HEAD-UP DISPLAY, AND ANGLE-SENSITIVE FILTER ARRANGEMENT WITH MICRO-LOUVERED GRATING

(71) Applicant: Carl Zeiss Jena GmbH, Jena (DE)

(72) Inventors: Siemen KUEHL, Jena (DE); Roman KLEINDIENST, Weimar (DE); Christoph ERLER, Jena (DE)

(73) Assignee: Carl Zeiss Jena GmbH, Jena (DE)

(21) Appl. No.: 19/472,321

(22) PCT Filed: Mar. 28, 2024
(86) PCT No.: PCT/EP2024/058498

§ 371 Date: Oct. 3, 2025

(30) Foreign Application Priority Data
Apr. 6, 2023 (DE) 10 2023 108 960.9
Apr. 25, 2023 (DE) 10 2023 110 525.6

(51) Int. Cl. G02B 27/01; G02B 1/11; G02B 5/18; G02B 5/22

(52) U.S. Cl. CPC G02B 27/0103; G02B 1/11; G02B 5/1866; G02B 5/22; G02B 2027/0105; G02B 2207/123

(57) ABSTRACT

An optical arrangement for a head-up display comprises one or more holographic optical elements and a filter arrangement. The filter arrangement comprises a micro-louvered grating and is configured for angle-selective filtering of light.

The present application is a National Phase patent application of PCT Appl No. PCT/EP2024/058498, filed Mar. 28, 2024, which claims priority from German Patent Appl. Nos. DE102023108960.9, filed on Apr. 6, 2023, and DE102023110525.6, filed Apr. 25, 2023, each of which is hereby fully incorporated herein by reference.

### FIELD OF THE INVENTION

Various examples of the disclosure relate to an optical arrangement for a head-up display. Various examples of the invention relate in particular to the use of a micro-louvered grating for reducing disturbing reflections caused by ambient light.

### BACKGROUND OF THE INVENTION

Head-up displays (HUDs; also referred to as windshield display device) are used in vehicles, for example, in order to generate a virtual image so that the driver does not have to look away from the road. The HUD comprises a plurality of main components: a projection unit and a wavefront manipulator.

The projection unit generates the optical information (e.g. speed, navigation instructions, warnings, etc.) which is used to generate a virtual image. In general, the projection unit is a compact projector mounted below the dashboard of the vehicle. The projection unit uses either lasers, light-emitting diodes or digital light processing (DLP) technology in order to generate the virtual images. The wavefront manipulator is an optical component that manipulates the light beams generated by the projection unit in order to generate a sharp and highly visible virtual image. The wavefront manipulator can consist of lenses, mirrors or one or more holographic optical elements (HOEs). The wavefront manipulator can be used to shape the light beams such that they focus at the correct distance. This gives the impression that the virtual image is hovering in the distance and the driver can easily read it, without needing to focus their eyes on a different distance. In contrast to a real image displayed on a physical surface (e.g. a screen), the virtual image is generated on a virtual image plane which, proceeding from the eyebox, is arranged behind the windshield (i.e. in the surroundings of the vehicle). The eyebox is the region in which the driver can clearly and distinctly see the virtual image. A well-designed eyebox enables the driver to perceive the HUD image from different viewing angles and head positions. DE 10 2021 105 830 discloses an HUD having one or more HOEs. It describes variants with a planar HOE and also with a curved HOE.

However, in the case of an HUD, under certain conditions, disturbing reflections may occur on account of ambient light. Some factors that may contribute to that are listed below. Insolation: Under direct or strong insolation, reflections and glare effects may occur, making the HUD more difficult to read. Interior lighting: Bright light sources within the vehicle, such as the dashboard or personal electronic devices, for instance, may generate reflections. External light sources: Strong external light sources, such as street lights, headlights of other vehicles or luminous advertising, may likewise cause reflections and glare effects.

In HUDs, it is desirable to deflect or even suppress disturbing reflections that are reflected in the direction of the driver or the eyebox via components of the HUD and may dazzle the driver. This effect occurs not only in conventional systems, but especially also in holographic HUDs. However, in comparison with conventional HUDs, disturbing reflections may additionally occur as a result of diffraction at the holograms.

DE 10 2019 131 729 A1 discloses an arrangement for suppressing reflections for a windshield display. This has a combination of grating elements and a cover sheet. Ambient light passes through the grating formed by the grating elements, impinges on the cover sheet and is reflected there. The reflected light is then absorbed at side surfaces of the grating elements. Such an arrangement has the disadvantage that it is comparatively large and bulky and system integration thus proves to be difficult owing to the typically limited installation space. See also DE 10 2019 132 600A1 .

### SUMMARY OF THE INVENTION

Aspects of the invention provide an optical arrangement for an HUD at a deflection surface, such as a windshield, for example, in which disturbing reflections on account of ambient light are reduced. The optical arrangement is intended to be compact and simple to manufacture and to have a good system integration capability.

What is disclosed is an optical arrangement which can implement an HUD at a deflection surface, for example a windshield. The optical arrangement comprises a projection unit. The latter is configured to emit light along a beam path. The beam path can have a plurality of partial beam paths, for example. The optical arrangement also has a wavefront manipulator. The latter is arranged along the beam path. The wavefront manipulator can have for example one or more of the following optical elements: mirror; freeform mirror; lens; HOE; a plurality of HOEs one behind another or next to one another; HOE stack. If one or more HOEs are used, these can be embodied in planar fashion, in particular. The optical arrangement also comprises a filter arrangement. The latter is configured to filter light in the angular range. The filtering also takes place in relation to ambient light which impinges on the filter arrangement in the opposite direction to that of the beam path. The filter arrangement can be implemented by a micro-louvered grating, in particular. The filter arrangement can be provided as a film and can have a curved surface.

The micro-louvered grating can be embodied in curved fashion, in particular. In the prior art, the micro-louvered gratings are embodied in planar or plane fashion. It has been ascertained that, firstly, the curvature of the micro-louvered grating does not, or not significantly, adversely affect the filter functionality of the micro-louvered grating; at the same time, however, the provision of the curvature enables light reflections to be steered particularly comprehensively away from the eyebox of the HUD.

The features set out above and features described below can be used not only in the corresponding combinations explicitly set out, but also in further combinations or in isolation, without departing from the scope of protection of the present invention.

### BRIEF DESCRIPTION OF THE DRAWINGS

FIG. 1 illustrates a head-up display which comprises a deflection surface and an optical arrangement comprising a projection unit, a wavefront manipulator with an HOE and a filter arrangement in accordance with various examples.

FIG. 2 schematically illustrates details concerning the filter arrangement in accordance with various examples.

FIG. 3 illustrates a segmentation of the filter arrangement in accordance with various examples.

### DETAILED DESCRIPTION OF THE INVENTION

The properties, features and advantages of this invention described above and the way in which they are achieved will become clearer and more clearly understood in association with the following description of the exemplary embodiments which are explained in greater detail in association with the drawings.

A description is given below of technologies which make possible an HUD with reduced light reflections and disturbing influences resulting from ambient light. What is disclosed in particular is an optical arrangement for an HUD at a deflection surface, for example a windshield. The deflection surface steers light to the eyebox. As a result, an observer perceives in the eyebox a (virtual) image which is arranged in a virtual image plane—not necessarily coincident with the deflection surface.

The optical arrangement includes a projection unit configured to emit light along a beam path. The beam path can comprise a plurality of partial beam paths.

The optical arrangement also comprises a wavefront manipulator. The latter is arranged along the beam path. In accordance with various examples, the wavefront manipulator comprises one or more HOEs. By way of example, the wavefront manipulator can comprise an HOE stack. The latter can be embodied e.g. in a shared recording material. The one or more HOEs can provide one or more of the following optical functionalities: deflecting light; collecting light; focusing; etc.

A description is given below in particular of technologies in which the wavefront manipulator comprises one or more holographic optical elements. It has been ascertained that especially with the use of holographic optical elements, the HUD is susceptible to disturbing reflections. This is owing to the fact that holographic reflections at the one or more holographic optical elements may generate additional disturbing reflections. Holographic reflections occur on account of diffraction effects at the periodic grating structure of an HOE. The periodic grating structure of the refractive index is formed in a recording material. In order to form the periodic grating structure, the recording material is exposed. By way of example, a volume HOE or a surface HOE can be used. That light which is generated by a holographic reflection may have a significantly different angle than the incident light.

Moreover, the optical arrangement also comprises a filter arrangement. The filter arrangement is configured to filter light in the angle space. That means that light is filtered depending on the angle at which the light is incident on the filter arrangement. Such an angle-selective filter arrangement is therefore different than, for example, a filter arrangement which filters light in the spectral range, i.e. depending on what wavelength the incident light has.

The filter arrangement serves to reduce disturbing reflections.

The filter arrangement is arranged downstream proceeding from the one or more HOEs along the beam path. The filter arrangement is thus arranged facing toward the deflection surface. If the optical arrangement is thus integrated into a system, the filter arrangement is arranged between the deflection surface and the one or more HOEs.

The filter arrangement comprises a micro-louvered grating. The micro-louvered grating allows light to pass which is incident on the filter arrangement within an angular bandpass range. Other light is reflected. Other light can be reflected in particular to a beam trap, or at any rate away from the eyebox.

The filter arrangement can have a curved surface. The curvature can be embodied such that ambient light which, from the direction of the deflection surface, is incident on the angle-selective louvered structure outside the angular bandpass range is at least partly reflected to the beam trap. This may involve Fresnel-reflected light which is reflected at a surface of the filter arrangement.

That light which passes through the micro-louvered grating within the angular bandpass range and is incident on the one or more HOEs and reflected there may then be outside the angular bandpass range after the reflection and can be prevented from passing through the filter arrangement. Therefore, such light does not pass to the eyebox.

Various examples are based on the insight that a planar embodiment of the one or more HOEs is made possible by means of such a filter arrangement. Especially in comparison with reference implementations in which the one or more HOEs are embodied in curved fashion (in order to avoid disturbing reflections to the eyebox by means of this curvature), particularly simple manufacture and simple system integration are possible. It has been ascertained that curved one or more HOEs or HOE stacks, for example, can be produced only with difficulty and system integration poses a challenge.

The use of the filter arrangement, which can be embodied especially suitably in curved fashion, then makes it possible, however, for the HOE stack to be embodied in planar fashion. The filter functionality is already provided by the filter arrangement.

Such examples are also based on the insight that a filter arrangement with a micro-louvered grating can be produced particularly simply in curved fashion. In particular, a filter arrangement with a micro-louvered grating can be curved more simply than a spectrally filtering filter arrangement.

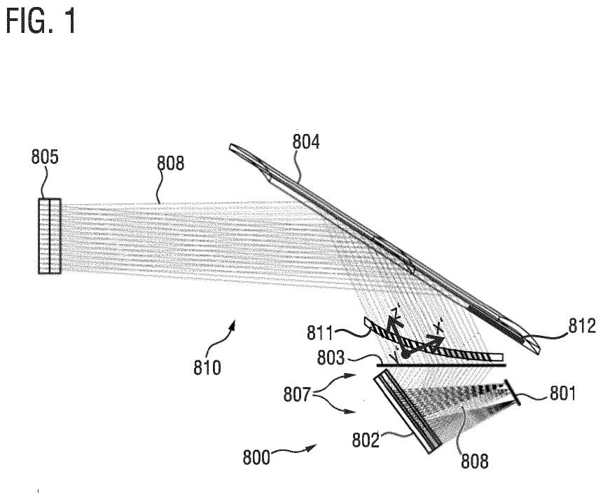

FIG. 1 schematically shows an HUD 810 in accordance with various examples. The HUD 810 comprises an optical arrangement 800. The optical arrangement 800 can be embodied e.g. as a module, i.e. can comprise a common housing. The optical arrangement 800 can then be integrated into a dashboard of a vehicle, for example.

The optical arrangement 800 comprises a picture generating unit or a projection unit 801 and a wave front manipulator 807.

A beam path 808 that generates a virtual image is generated by means of the optical arrangement 800. The virtual image is perceived from the eyebox 805. For this purpose, the windshield is provided as a deflection surface 804, which deflects the beam path 808 proceeding from the projection unit 801 to the eyebox 805. The windshield can be embodied in curved fashion.

In the variant illustrated, the wavefront manipulator 807 comprises a reflective optical element 802 and one or more HOEs 803. However, other implementations of the wavefront manipulator are possible.

The reflective optical element 802 can have a freeform surface and is arranged in the beam path 808 proceeding from the projection unit 801 between the projection unit 801 and the one or more HOEs 803. By way of example, the optical element 802 is a freeform mirror.

The one or more HOEs 803 form e.g. an HOE stack. The one or more HOEs 803 are embodied in planar fashion. The one or more HOEs 803 can deflect light or provide a lens functionality, for example. These HOEs function in a similar manner to conventional lenses or mirrors, but with the advantage that they are lighter, thinner and more flexible. Holographic lenses can be used to shape or focus light beams of the beam path 808 in such a way that the virtual image is generated at a desired distance from the windshield 804 or in a well-defined virtual image plane.

It would be conceivable for an antireflection coating to be applied to the one or more HOEs 803 for example on a surface of an HOE stack or a protective film or a cover glass. The antireflection coating extends along the one or more HOEs. The antireflection coating can be arranged in particular on that side of the one or more HOEs 803 which faces toward the filter arrangement 811. In this way, it is possible to reduce Fresnel reflections of light at this interface of the recording material of the one or more HOEs 803 to the surroundings.

The specific implementation of the HOE 803 or of a plurality of HOEs 803 or of the other components of the wavefront manipulator 807 is not crucial for the technologies described herein. Various variants can be used and flexibly combined with the disclosed technologies for reducing disturbing reflections. However, the technologies described herein are especially suitable for enabling an effective reduction of disturbing reflections in the eyebox 805 also for a planar configuration of the one or more HOEs 803—as illustrated in FIG. 1. It is not necessary for the one or more HOEs 803 to be embodied in curved fashion in order to avoid the disturbing reflections in the eyebox 805. Owing to the possibility of embodying the one or more HOEs 803 in planar fashion, the manufacture of the one or more HOEs 803 is simplified. System integration, too, for example arrangement in the dashboard, is simplified.

For reducing disturbing reflections, the HUD 800 also comprises a filter arrangement 811. By way of example, disturbing reflections can already be reduced by an antireflection coating of the one or more HOEs 803; it is then possible to reduce the disturbing reflections even further by providing the filter arrangement 811.

The filter arrangement 811 filters light and is arranged downstream—proceeding from the one or more HOEs 803—along the beam path 808, that is to say in a manner facing toward the windshield or deflection surface 804. The filter arrangement 811 thus offers as it were a termination of the optical arrangement 800. Since the filter arrangement 811 is not situated in or in the vicinity of an intermediate image in the HUD beam path, no image contents of the virtual image are shaded.

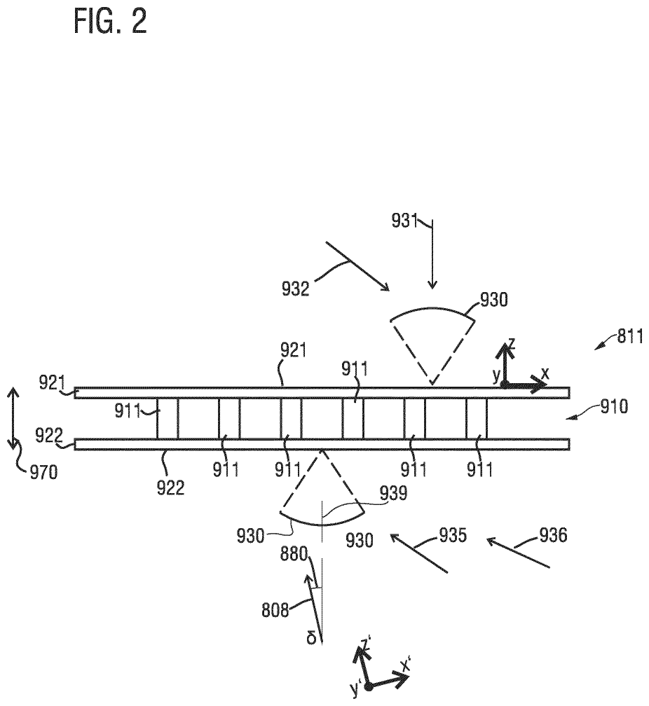

The filter arrangement 811 is configured for angle-selective filtering of light. That is to say that, depending on the angle of incidence of the light on the filter arrangement 811, the light can pass through the filter element 811 or is absorbed or reflected there. One exemplary implementation of the filter element 811 is illustrated in association with FIG. 2.

FIG. 2 shows aspects in connection with the filter arrangement 811. FIG. 2 is a side view. In the example in FIG. 2, the filter arrangement 811 has a micro-louvered grating 910. The micro-louvered grating provides the angle-selective filter functionality.

Such implementations of angle-selective filter arrangements by means of micro-louvered gratings are known in principle from the field of privacy films for displays. In that case, the angle-selective filter functionality of filter arrangements with micro-louvered gratings is used to prevent unauthorized persons from recognizing the information presented on the screen. In the present case, the angle-selective filter functionality of the filter arrangement 811 with the micro-louvered grating 910 is used to reduce disturbing reflections.

The louvered grating 910 comprises a plurality of louvers 911 in a line grating (the louvers are extended along the y-axis, i.e. perpendicular to the plane of the drawing). The louvers are typically produced from plastic or polymer. Light either is blocked or can pass/be transmitted through the filter arrangement, depending on the direction (or angle) from which the light is incident on the filter arrangement 811.

The accepted angular spectrum which can be transmitted through the micro-louvered grating (angular bandpass range 930) can be controlled by way of the geometric parameters of louver height, louver width, louver tilt and louver spacing. By way of the fill factor (louver spacing to louver width), the transmission of the accepted light can be set (1:1 means that approximately half of the light is transmitted). This offset can be compensated for e.g. by a higher luminous flux of the projection unit.

These geometric parameters can be fixed, for example by the corresponding micro-louvered grating being embedded in a layer stack of a corresponding film.

One exemplary configuration of the louvers 911 has the following parameters: louver height: 200 μm; louver width: 60 μm; louver spacing: 60 μm; louver tilt: 24° relative to the z-axis of the curved basic contour. In this case, the z-axis is always oriented perpendicular to the surface 921, 922 and therefore varied as a function of the position on the louvered grating 910, i.e. as a function of the x-position and optionally also as a function of the y-position for a 2D curvature; the x-y-z-axes are thus a local coordinate system which is defined in each case for any position on the surface of the filter arrangement 811; a global coordinate system x′-y′-z′ is also shown, which is fixed in space. In the example illustrated, the global coordinate system is chosen such that the z′-axis is oriented parallel to the beam path 808, although various definitions are conceivable.

It is evident from the above description of exemplary geometric parameter values for the louvers 911 that the louvers 911 have dimensions in the micrometer range. A micro-louvered grating is therefore involved. The use of a micro-louvered grating enables the filter arrangement 811 to be embodied as a film. That means that a total dimension 970 from a top side 921 (facing toward the deflection surface 804) to an underside 922 (facing toward the one or more HOEs 803) can be in the sub-millimeter range; typically in the range of less than half a millimeter. For this purpose, the filter arrangement 811 has a layer stack. The latter has the micro-louvered grating 910 between two transparent protective layers 921, 922.

FIG. 2 illustrates that the angular bandpass range 930 of the filter arrangement 811 is adapted to angles 880 of incidence (also designated by & in the figures) of the light which is incident on the filter arrangement 811 along the beam path 808 proceeding from the projection unit 801. That means that this light of the beam path 808 can pass through the filter arrangement 811 and can thus form the virtual image. (While FIG. 2 shows the filter arrangement 811 as planar, it would generally be possible for the filter arrangement 811 to be curved.)

FIG. 2 also illustrates that ambient light 931, 932 from the region of the deflection surface 804 or else from the interior of the motor vehicle can be incident on the filter arrangement 811. By way of example, since the ambient light 932 lies outside the angular bandpass range 930, it is filtered by the filter arrangement 811, that is to say cannot be transmitted to the one or more HOEs. Such ambient light 932 is partly Fresnel-reflected at the surface of the filter arrangement 811. Fresnel reflections are light reflections that arise when light is incident on the surface of a material that differs from the surrounding medium in regard to the optical properties (refractive index). Depending on the type of incident light (polarization) and the angle of incidence, Fresnel reflections may vary in magnitude.

These Fresnel reflections of the ambient light 932 can be steered away from the eyebox 805 in a targeted manner by virtue of a suitable curvature of the filter arrangement 811. Especially one-dimensional curvatures (as shown in FIG. 1) are conceivable; however, two-dimensional curvatures would also be possible. By way of example, a beam trap 812 (cf. FIG. 1) can be provided adjacent to the filter arrangement 811 and the ambient light 932 can be reflected off the filter arrangement 811 and pass to the beam trap 812.

Generally, a beam trap, also referred to as light trap, is an optical element that is used to reduce or eliminate unwanted light in optical systems. Beam traps work by absorbing unwanted light beams.

If the ambient light 923 is not Fresnel-reflected at the surface of the filter arrangement 811, then it can be absorbed at an inner side of the louvers 911 (if the angle of incidence of the light lies outside the angular bandpass range).

FIG. 2 also shows ambient light 931 lying within the angular bandpass range 930. This ambient light 931 passes (at least predominantly) through the filter arrangement 811 and is then reflected at the one or more HOEs. By way of example, Fresnel reflections and holographic reflections occur. The proportion of such Fresnel reflections can be further reduced for example by an antireflection coating on the top side of the recording material of the one or more HOEs, which faces toward the filter arrangement 811.

A significant proportion of the ambient light 931 which—after a first transmission through the filter arrangement 811—is subsequently reflected at the one or more HOEs 803 lies outside the angular bandpass range 930 upon second incidence on the filter arrangement 811, cf. light 935 in FIG. 2. The light 935 cannot pass through the filter arrangement 811 and therefore does not pass to the eyebox 805.

Light which is emitted by the projection unit 801 along the beam path 808 and which does not correspond to desired diffraction maxima at the one or more HOEs 803 (for example, typically the first diffraction maximum, i.e. the first order of diffraction, is used in order to provide the desired optical functionality; the zero diffraction maximum then corresponds to light which is not intended to pass to the eyebox 805) is also filtered at the filter arrangement 811. That means that e.g. that portion of the light diffracted at the one or more HOEs 803 which corresponds to the zero order of diffraction cannot be transmitted through the filter arrangement 811 to the eyebox 805. Such light may optionally also experience a Fresnel reflection at the interface between the recording material of the one or more HOEs 803 and the surroundings. Such light which corresponds to the zero order of diffraction may also experience diffraction at the one or more HOEs 803 following a Fresnel or total internal reflection.

Furthermore, further stray light 936 shown in FIG. 2 is also filtered by the filter arrangement 811. The stray light 936 is emitted by the projection unit 801 along a stray light beam path. By way of example, the stray light 936 may arise as a result of unwanted reflections at an optical component of the projection unit 801. In this case, the stray light beam path is different than the beam path 808 used for the HUD functionality. By way of example, the stray light beam path does not need to run through the one or more HOEs 803. It would be conceivable for the stray light beam path to run through the one or more HOEs 803 but be incident on the one or more HOEs 803 outside an acceptance angle range, such that the stray light 936 is not diffracted at the one or more HOEs 803. It would be conceivable for the stray light 936 to experience a Fresnel reflection at a transition between a recording material of the one or more HOEs 803 and the surroundings. The stray light 936 is incident on the filter arrangement 811 outside the angular bandpass range 930 and cannot pass through said filter arrangement. What is evident from all that is that in principle there is an endeavor to make the dimensioning of the angular bandpass range 930 as small as possible and to adapt this range as well as possible to the beam path 808. The dimensioning of the angular bandpass range 930 is intended to be small enough that as little ambient light as possible can pass through the filter arrangement 811; at the same time, the dimensioning of the angular bandpass range 930 needs to be large enough that the light emitted by the projection unit 801 can pass through the filter arrangement 811 along the beam path 808. The angular bandpass range 930 is thus adapted to the light emitted by the projection unit 801.

One option for adapting the angular bandpass range 930 to the beam path 808 of the light emitted by the projection unit 801 consists in the targeted choice of the orientation of the louvers 911 parallel to the beam path. The angular bandpass range 930 in the angle space can thus be arranged for example centered with respect to the beam path 808 (in the example in FIG. 2, a small tilt of the central axis 939 of the angular bandpass range 930 relative to the beam path 808 is depicted, which may sometimes be required on account of the curvature of the surfaces 121, 922 of the micro-louvered grating 910; in this case, it was ascertained that a tilt of approximately +/−10° may be referred to as “substantially perpendicular”, i.e. has correspondingly good filter properties). In detail, in the various examples it may be possible for the louvers 911 to have a tilt which varies continuously or step by step (in segments) as a function of the position along the micro-louvered grating 910. In this case, the tilt of the louvers 911 can be defined locally in relation to the surface 921, 922. In the illustrated example in FIG. 2, the louvers 911 are oriented perpendicularly, that is to say have a tilt of 0°. However, it would also be conceivable for the louvers to have a tilt for example in a range of from minus 30° to plus 30°, wherein the tilt optionally varies continuously or step by step along the position on the surface 921, 922. Such an adapted and spatially variable tilt enables the angular bandpass range 930 to be adapted in a targeted manner to the angle 880 of incidence of the beam path 808. In particular, a varying orientation of the surface 921, 922 with respect to the beam path 808 as a function of location on account of the curvature can be compensated for by a corresponding oppositely directed tilt of the louvers 911. The louvers 911 can thus each be tilted such that at all points they are oriented approximately parallel to the beam path 808.

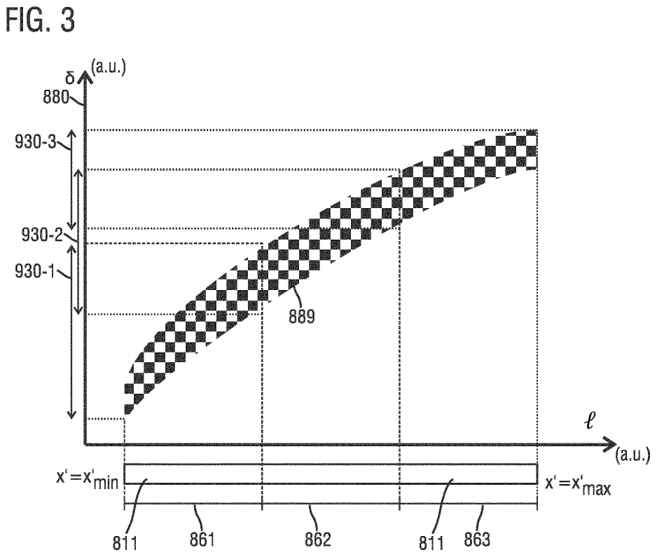

Such a variable tilt of the louvers 911 can be attained by means of a segmentation of the micro-louvered grating 910 or of the filter arrangement 811. Different angular bandpass ranges 930 are implemented in each of the various segments. That means, therefore, that the angular bandpass range 930 varies along the filter arrangement 811. Corresponding technologies are explained below in association with FIG. 3.

FIG. 3 illustrates the angular range 889 (area marked by checkered pattern) encompassing those angles 880 of incidence (defined relative to the z-axis of the local coordinate system) from which light of the beam path 808 is incident on the filter arrangement 811 at different positions. In other words, the angle δ between the respective surface normal to the respective surface 921, 922 of the filter arrangement 811 and the light incident along the beam path is shown. The vertical plot axis is an angle dimension, for example measured in °(however, FIG. 3 shows arbitrary units in order to illustrate the concept instead of concrete quantitative dependencies). On the horizontal axis of the plot from FIG. 3, the extent along the surfaces 921, 922 is shown, from the end of the filter arrangement for small x′ to the opposite end of the filter arrangement for large x′. This position coordinate is designated by l. The horizontal diagram axis in FIG. 3 is therefore a spatial dimension, i.e. l is measured e.g. in mm (however, FIG. 3 shows arbitrary units in order to illustrate the concept instead of concrete quantitative dependencies). Put simply, FIG. 3 shows how the angle 880 of incidence changes from the left-hand end of the filter arrangement 811 (as shown in FIG. 1) to the right-hand end of the filter arrangement 811 (as shown in FIG. 1).

It is evident from FIG. 3 that this angular range 889 varies significantly. In particular, that is owing to the curvature of the filter arrangement 811.

Accordingly, the filter arrangement 811 has three segments 861, 862, 863, each having different geometries of the corresponding louvers 911. By way of example, the louvers can each be embodied with different widths and/or with different spacings and/or can be tilted differently. As a result, the regions 861, 862, 863 have different angular bandpass ranges 930-1, 930-2, 930-3. These angular bandpass ranges 930-1, 930-2, 930-3 are embodied such that the light 880 emitted by the projection unit 801 can pass along the beam path 808; they are thus adapted to the angular range 889. A typical width for the angular bandpass ranges 930, 930-1, 930-2, 930-3 used is in the range of 5° to 30° (in the film material).

While in the example in FIG. 3, only three segments 861-863 are shown, the filter arrangement 811 could also have fewer or more segments with different angular bandpass ranges. While FIG. 3 shows a stepwise variation of the angular bandpass ranges, a gradual variation by way of a gradual variation of the geometric parameters of the louvers 911 could also be used. By way of example, one or more geometric parameters could be varied from louver 911 to louver 911. By way of example, adjacent louvers could have slightly different inclination angles.

In summary, a description has been given of technologies which, by means of a filter arrangement that filters light in the angle space, make it possible to reduce disturbing reflections in the eyebox of an HUD, especially if a corresponding optical arrangement uses one or more HOEs.

Without the filter arrangement 811, critical Fresnel reflections in the direction of the eyebox 805 occur at the planar top side of the one or more HOEs 803. With the curved filter arrangement 811, however, the ambient light 931, 932 can be incident on the one or more HOEs 803 only from a defined bandpass range 930. Moreover, on account of the curvature of the filter arrangement 811, fewer or no Fresnel reflections that emit light to the eyebox 805 are generated at a surface of the filter arrangement 811.

The dimensioning of the angular bandpass range 930 is therefore made as small as possible (in order that as little ambient light as possible can pass through the filter arrangement 811 and be incident on the one or more HOEs 803), but as large as necessary (in order that the light 880 can pass through the filter arrangement 811 along the beam path 808). In particular, it is possible to use a plurality of segments with different angular bypass ranges 930-1-930-3, as described in association with FIG. 3. If critical holographic reflections of that portion of the ambient light which can pass through the filter arrangement 811 (cf. FIG. 2, ambient light 931) are still present, then a bandpass filter presented in DE 10 2022 214 243 can additionally be integrated.

It goes without saying that the features of the embodiments and aspects of the invention described above can be combined with one another. In particular, the features can be used not only in the combinations described but also in other combinations or on their own, without departing from the scope of the invention.

1. An optical arrangement for a head-up display at a deflection surface, wherein the optical arrangement; comprises:
a projection unit configured to emit light along a beam path,
one or more holographic optical elements arranged along the beam path, and
a filter arrangement, which is arranged downstream proceeding from the one or more holographic optical elements-and which comprises a micro-louvered grating configured for angle-selective filtering of incident light.

2. The optical arrangement as claimed in claim 1,
wherein the filter arrangement has a curved surface.

3. The optical arrangement as claimed in claim 2,
wherein louvers of the micro-louvered grating have a spatially variable tilt relative to the curved surface.

4. The optical arrangement as claimed in claim 2,
wherein the variable tilt of the louvers varies in such a way that the louvers are oriented substantially parallel to the beam path.

5. The optical arrangement as claimed in claim 1, furthermore comprising:
a beam trap arranged adjacent to the filter arrangement.

6. The optical arrangement as claimed in claim 5,
wherein the beam trap is arranged in relation to the filter arrangement in such a way that ambient light reflected at a surface of the filter arrangement at least partly passes from the filter arrangement to the beam trap.

7. The optical arrangement as claimed in claim 1,
wherein the filter arrangement has a plurality of segments with different angular bandpass ranges of the angle-selective filtering of the micro-louvered grating.

8. The optical arrangement as claimed in claim 7,
wherein the angular bandpass ranges vary in a stepwise manner or continuously.

9. The optical arrangement as claimed in claim 7,
wherein one or more angular bandpass ranges of the angle-selective filtering of the micro-louvered grating are adapted to angles of incidence of the light which is emitted by the projection unit and is incident on the filter arrangement along the beam path.

10. The optical arrangement as claimed in claim 1,
wherein the one or more holographic optical elements are embodied in planar fashion.

11. The optical arrangement as claimed in claim 1,
wherein the filter arrangement has a layer stack,
wherein the micro-louvered grating is arranged between two transparent protective layers of the layer stack.

12. The optical arrangement as claimed in claim 1,
wherein the filter arrangement is embodied as a film.

13. The optical arrangement as claimed in claim 1,
wherein the filter arrangement is configured to filter one or more predetermined orders of diffraction of light diffracted at the one or more holographic optical elements.

14. The optical arrangement as claimed in claim 13,
wherein the one or more predetermined orders of diffraction comprise the zero order of diffraction.

15. The optical arrangement as claimed in claim 13,
wherein the filter arrangement is configured to filter the one or more predetermined orders of diffraction of the light diffracted at the one or more holographic optical elements after the light has experienced a reflection at an optical interface.

16. The optical arrangement as claimed in claim 1,
wherein the projection unit is configured to emit stray light along a stray light beam path,
wherein the filter arrangement is configured to filter the stray light.

17. The optical arrangement as claimed in claim 1, furthermore comprising:
an antireflection coating extending along the one or more holographic optical elements.

18. The optical arrangement as claimed in claim 17,
wherein the surface on which the antireflection coating is applied faces toward the filter arrangement.
